(19) United States
(12) Patent Application Publication
(10) Pub. No.: US 2007/0150132 A1
(43) Pub. Date: Jun. 28, 2007

(54) Integrated electric motor control/transmission control system for use with variable transmissions in electric vehicles

(76) Inventors: Leonard A. DuCharme, American Fork, UT (US); Paul Ressler, American Fork, UT (US)

Correspondence Address: Leonard A. DuCharme, 892 N. 340E., American Fork, UT, 84003, US

(21) Appl. No.: 11/606,822

(22) Filed: Nov. 30, 2006

Related U.S. Application Data
(60) Provisional application No. 60/748,935, filed on Dec. 12, 2005.

(51) Int. Cl. G06F 17/00

(52) U.S. Cl. 701/22

(57) ABSTRACT

The invention is an integrated motor-control/transmission control system for use with variable transmissions (IVT and CVT) in electric vehicles. The system allows an electric motor to operate a higher percentage of its total operating time at or close to peak efficiency than is allowed under PWM-style systems by allowing the motor to accelerate to peak without a load, or alternatively, with a relatively low load and then by utilizing a variable transmission to accelerate the vehicle.

### PRIORITY CLAIM

The present application claims the benefit of U.S. Provisional patent application Ser. No. 60/748935, filed Dec. 1, 2005, and entitled INTEGRATED ELECTRIC MOTOR CONTROL/TRANSMISSION CONTROL SYSTEM FOR USE WITH VARIABLE TRANSMISSIONS IN ELECTRIC VEHICLES

### BACKGROUND

1. Field of the Invention

The present invention relates generally to electric-motor control systems. More particularly, the present invention relates to a design for an integrated motor-control/transmission control system for use with infinitely variable transmissions (IVT) and continuously variable transmissions (CVT) in electric vehicles. The system allows an electric motor to be accelerated to peak rpm, where motor efficiency is at its highest level, prior to engagement of the transmission. To accelerate the vehicle, an operator, applies the accelerator. This input, rather than affecting RPM acceleration, is used to adjust the infinitely variable transmission (IVT) off its zero point, at which stage, the vehicle begins to accelerate. (Note that because the motor is already at peak torque, this initial acceleration requires much less amperage draw than if the motor, at very low RPM, were beginning the acceleration of the vehicle.) As the operator continues to apply the accelerator, the IVT continues to adjust into higher gearing ratios, causing the vehicle to accelerate. However, as the IVT adjusts, increased load is added to the motor. Depending on the rate of adjustment of the IVT and the additional load added to the motor, motor RPM could begin to slow, in turn, causing amperage draw to increase. Here, the control system, which monitors and limits amperage range, interacts with the IVT to slow the rate of ratio increase, thereby, allowing motor RPM to continue at or near peak range.

2. Related Art

The current standard for motor control in many electric vehicle applications is PWM (Pulse Width Modulation). In this type of system, a PWM controller resides between a DC battery and an electric motor. Based on external commands, the PWM inserts gaps in the current from the battery before feeding the current to the motor. The wider the gaps, the slower the motor's rotor turns. The narrower the gaps, the faster the rotor turns. Eliminating the gaps altogether allows the motor to turn at peak RPM, depending on the load placed on the motor. The PWM controls the maximum amperage allowed to the motor.

The PWM approach to motor control in electric vehicles has many limitations. These limitations result from the operational paradigm of an electric vehicle based on PWM technology, which paradigm was borrowed from internal-combustion-engine (ICE)-powered vehicles. In this paradigm, increasing the RPM of the motor results in acceleration of the vehicle. An integrated, automatic transmission works in unison with the engine to accelerate the vehicle up to speed. Such transmissions generally make shifting decisions on a variety of external data, including engine RPM—when RPM rises to a high enough level, the transmission shifts to a higher gear. With manual transmissions, the operator makes the shifting decision, again, generally based on engine RPM.

The ICE paradigm results from the operational characteristics of ICEs:
ICEs are designed to perform in a wide RPM range.
Most ICEs tend to operate at an acceptable efficiency throughout much of the engine's total RPM range.
ICEs (especially four-stroke ICEs) tend to have a maximum efficiency point well below the middle of the engine's total RPM range. For example, an ICE that has a maximum RPM of 9000 may operate at peak efficiency at 2500 RPM. Consequently, the upper RPM range is used for acceleration only. Prolonged operation of an ICE in its upper RPM range could result in excessive wear or damage to the engine.
Increasing the flow of fuel to the pistons results in an increase of motor RPM.

These operational characteristics led vehicle designers to create components that would accentuate the capabilities of ICEs, such as clutches and gear-based transmissions, the result being ICE-powered cars, trucks, etc. as we now know them: vehicles in which increased fuel to the engine results in acceleration of engine RPM, which, in turn, results in vehicle acceleration.

Because electric motors have operating characteristics radically different from ICEs, designing an electric vehicle based on PWM technology, which emulates the ICE paradigm, results in an inefficient vehicle:
Electric motors are designed to operate at a specific, very narrow, peak range.
The peak range of most electric motors is near its peak RPM capability. For example, a motor with peak RPM capability of 4100 may achieve peak efficiency at 3600 RPM.
The further an electric motor gets from its peak, the more inefficient it becomes. For example, a motor that operates at 90% efficiency at a peak RPM of 4000 may operate at 50% efficiency at 2000 RPM.
In a motor operating at peak RPM, increasing the amperage available to the motor will not result in increased RPM.
In order to operate an electric motor at an RPM less than peak, a Pulse Width modulator, or other external technology, must be used to modify the electrical current going to the motor.

Accelerating motor RPM as a methodology for accelerating the vehicle—the ICE paradigm—is an inneficient approach with an electrical system: A typical electric motor, starting from 0 RPM under a load, has poor efficiency during acceleration. Given that most city driving consists mostly of stops and starts, the ICE-paradigm, applied to an electric vehicle, results in a motor running far outside of peak efficiency as much as 80% to 90% of the total operating time. The result is an electric vehicle that has a poor range-to-battery-payload ratio. In other words, the vehicle won't go very far even though it has a relatively large amount of battery storage capacity. Furthermore, the inefficiency that results from running the motor at less than peak efficiency converts into heat, both in the motor and in the PWM controller. Excessive heat buildup can shorten the operating life of both the motor and controller.

Exacerbating the inherent problems of the PWM approach to motor control in electric vehicles are geared transmissions, which, when a vehicle is at rest, require the motor to begin at low RPM. As was previously stated, electric motors are inherently unsuited to this type of application, having poor torque and efficiency at RPM much lower than peak RPM efficiency.

### SUMMARY

It has been recognized that it would be advantageous to develop a motor control system for electric vehicles based on a new paradigm specifically suited for the operational characteristics of electric motors when used in conjunction with infinitely variable transmissions.

In accordance with one aspect thereof, the invention provides an electric motor; an infinitely variable transmission (IVT) with motor drive; an amperage-limiting, motor-control circuit with integrated transmission control; a dashboard readout; and an electronic accelerator. When an operator begins to depress the accelerator, the motor is immediately accelerated to peak range without load. As the operator continues to depress the accelerator, the control system causes the IVT to move slightly off its zero point, and the vehicle begins to move. As the operator continues to apply pressure to the accelerator, the IVT continues to adjust through higher gearing ratios, resulting in the acceleration of the vehicle. However, as the IVT adjusts, increased load is added to the motor, causing RPM to slow, in turn, causing amperage draw to increase. At this point, a warning light in the dash board comes on, indicating to the operator that the rate of acceleration is too great for optimal motor efficiency. The operator can then choose, or not, to decrease the rate of acceleration. If the operator backs off on the accelerator, the control system will cause the transmission to slow, or stop, its progression into higher ratios, thereby, allowing motor RPM to continue at or near peak range.

In accordance with another aspect thereof, the invention provides an electric motor; an infinitely variable transmission with motor drive; an amperage-limiting, motor-control circuit with integrated transmission control; and an electronic accelerator. When an operator begins to depress the accelerator, the motor is immediately accelerated to peak range without load. As the operator continues to depress the accelerator, the control system causes the IVT to move slightly off its zero point, and the vehicle begins to move. As the operator continues to apply the accelerator, the IVT continues to adjust through higher gearing ratios, resulting in the acceleration of the vehicle. However, as the IVT adjusts, increased load is added to the motor, causing RPM to slow, in turn, causing amperage draw to increase. Based on a preset, operator-defined amperage range limiter built into the control circuit, if the amperage draw exceeds the limit, the control circuit will then cause the IVT to slow, or stop, its progression into higher ratios, thereby, allowing motor RPM to continue at or near peak range.

In accordance with another aspect thereof, the invention provides an electric motor; a continuously variable transmission (CVT) with motor drive; an amperage-limiting, motor-control circuit with integrated transmission control; and an electronic accelerator. When an operator begins to depress the accelerator, a pulse-width-modulation circuit is used to accelerate the vehicle from a stop using the lowest gearing ratio that the CVT is capable of At the point where the drive motor reaches peak RPM, the transmission control circuit can begin adjusting the CVT to provide an increase in vehicle speed. As the operator continues to depress the accelerator, the control system causes the CVT to continue to be adjusted up through higher gearing ratios, resulting in the acceleration of the vehicle. However, as the CVT adjusts, increased load is added to the motor, which may cause RPM to slow, in turn, causing amperage draw to increase. Based on a preset, operator-defined amperage range limiter built into the control circuit, if the amperage draw exceeds the limit, the control circuit will then cause the CVT to be adjusted to a lower gearing ratio, or to stop its progression into higher ratios, thereby, allowing motor RPM to continue at or near peak range.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein

FIG. 1 shows the performance graph of a typical electric motor that may be used in an electric vehicle.

FIG. 2 shows an example performance graph of an electric motor operating under the inventive motor/transmission control system.

FIG. 3 shows the spatial configuration of the system components utilizing a dashboard warning light to indicate when acceleration is causing excessive amperage draw.

FIG. 4 shows the spatial configuration of the system components utilizing an amperage limiting circuit to control acceleration.

FIG. 5 shows the spatial configuration of the system utilizing a continuously variable transmission (CVT) rather than an IVT.

### DETAILED DESCRIPTION

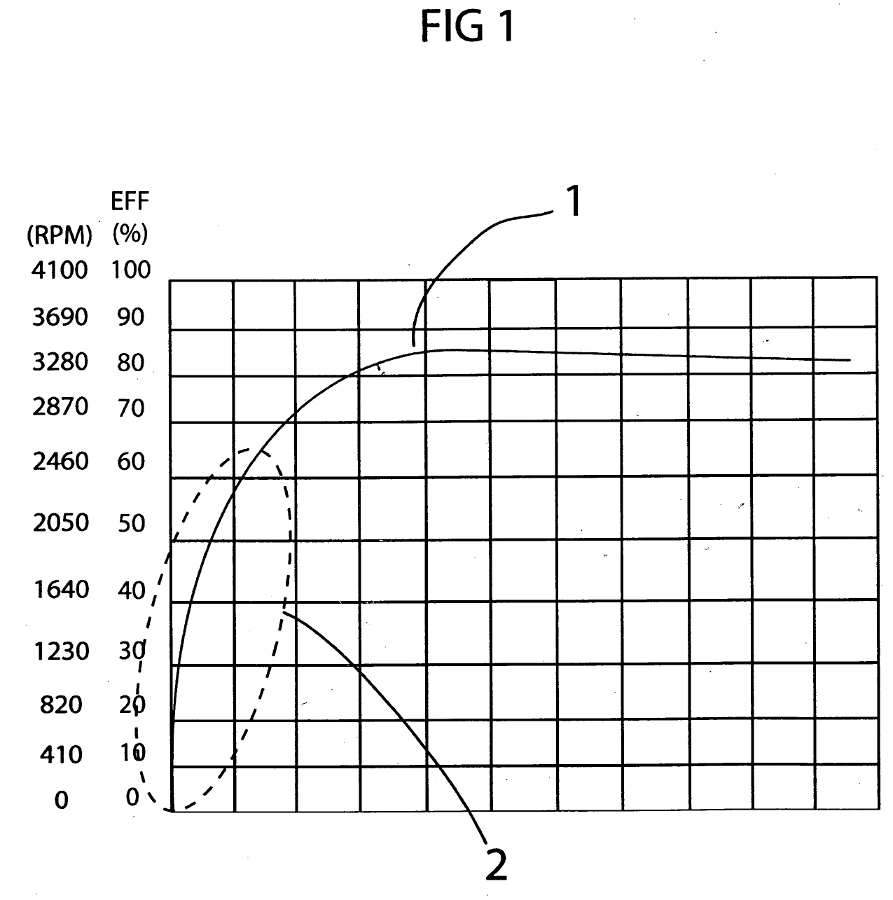

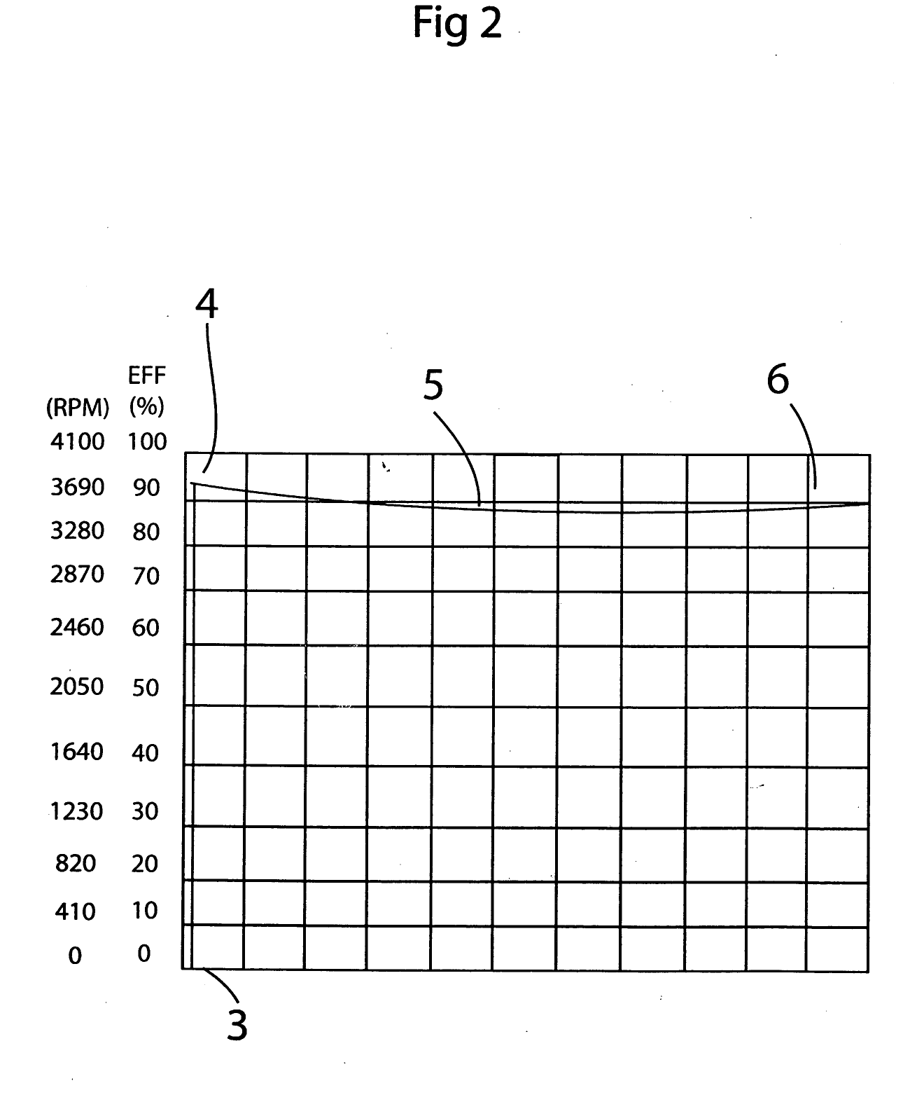

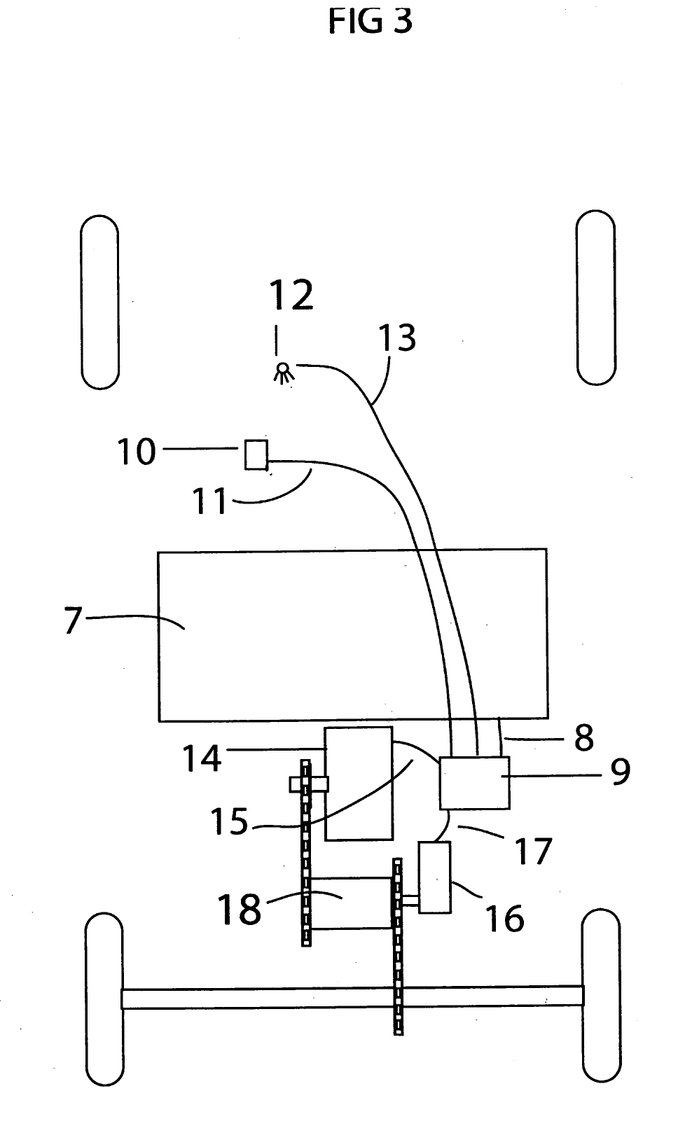

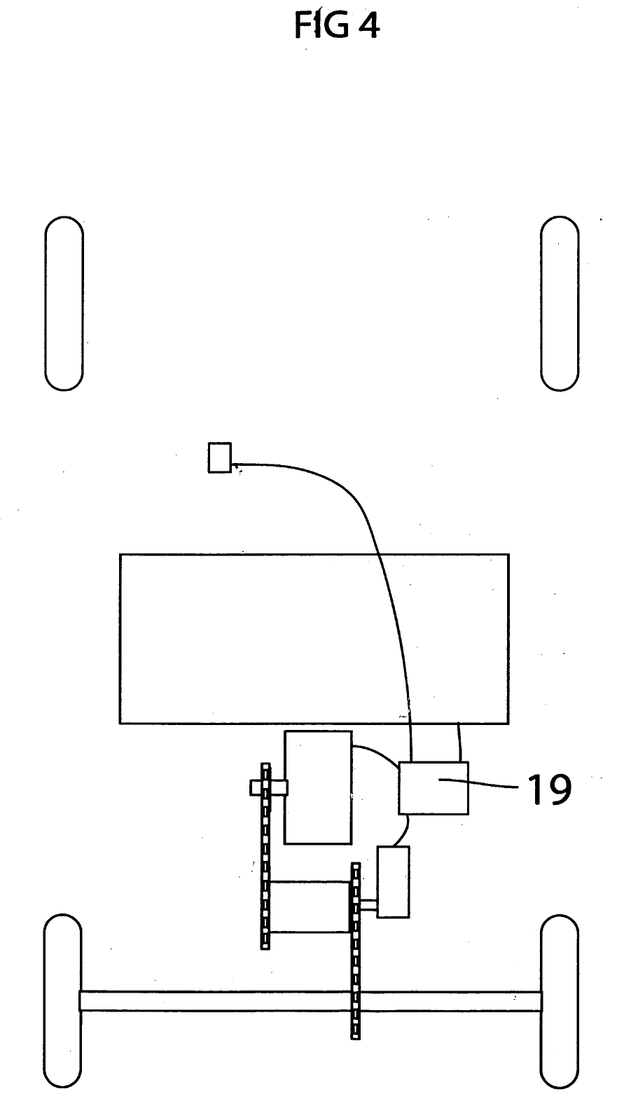

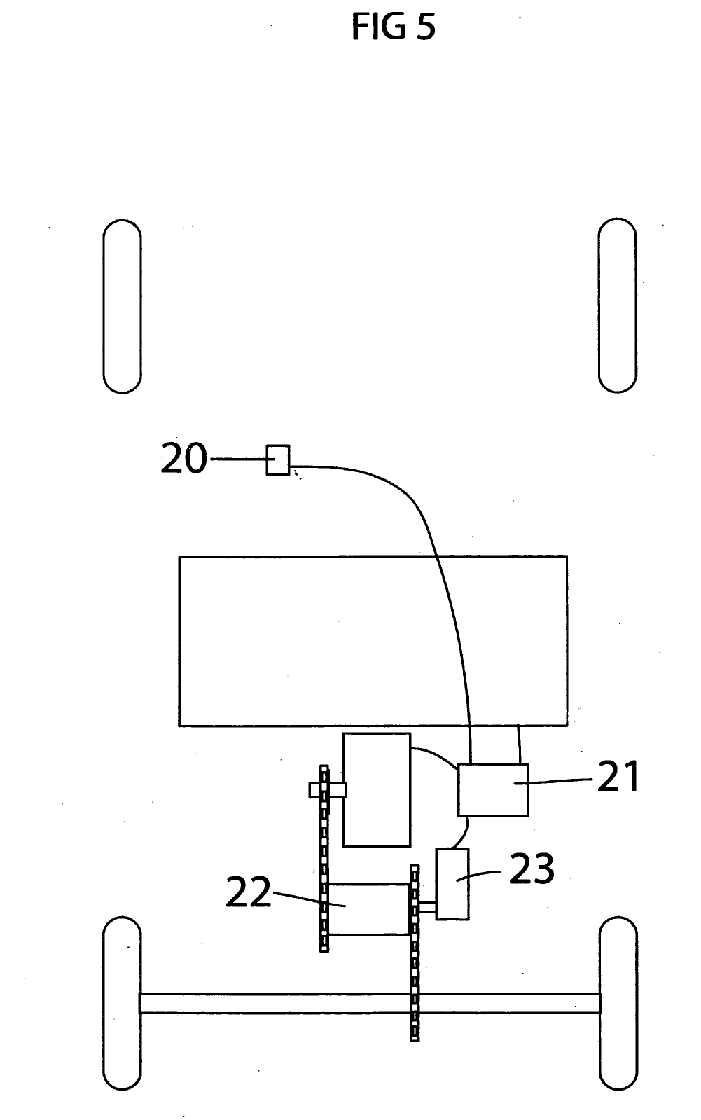

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.
The invention advantageously utilizes an integrated motor control/IVT control circuit in conjunction with an IVT transmission to create a highly efficient electrical system for electric vehicles.
FIG. 1 shows the technical performance characteristics of a typical electric motor. The example motor achieves peak efficiency of approximately 85% at an RPM of approximately 3400 1. Utilizing the ICE paradigm—accelerating RPM as a means of accelerating the vehicle—a typical electric vehicle driven in city traffic would spend the large majority of its operating time at an RPM dramatically lower than peak efficiency 2.
FIG. 2 shows the performance specifications of an electric motor operating under the integrated motor control/IVT control system. Before the accelerator is depressed, the motor is at rest 3. As the accelerator is depressed, the electric motor is engaged without load. Because there is no load, the motor immediately accelerates to peak RPM 4. As the accelerator is depressed further, the integrated control interacts with the drive motor on the IVT, which moves the IVT off its zero point. As the vehicle begins to accelerate, a load is imposed on the motor, which causes the RPM to begin to slow 5, conversely decreasing motor efficiency. The integrated control recognizes that the motor is slowing—losing efficiency—and makes adjustments to the IVT, allowing the motor to move back into peak range 6 while still allowing the vehicle to accelerate. Note that under extreme conditions, either efficiency or acceleration must be sacrificed.
FIG. 3 shows the spatial configuration of the system components utilizing a dashboard warning light to indicate when acceleration is causing excessive amperage draw. The battery 7 can be any type of appropriate storage cell or fuel cell. The battery is wired 8 directly to the integrated motor control/IVT control 9. The accelerator 10 can be a hall effect device, potentiometer device, or any other electronic device of appropriate nature. The accelerator is wired 11 directly to the integrated control. The amperage warning light 12 is wired 13 directly to the integrated control. The motor 14 is wired 15 directly to the integrated control. The IVT drive motor 16 is wired 17 to the integrated control. The IVT drive motor is connected to the infinitely variable transmission 18. Such transmissions are available from Fallbrook Technologies, of San Diego, Calif., or from HydraGear Corporation The motor transfers power to the IVT via chain 19, belt, or drive shaft. The IVT transfers power to the rear axle via chain 20, belt, or drive shaft. When the operator depresses the accelerator, the electric motor is accelerated to peak without a load. To avoid damage to the motor or system components, a soft-start feature should be incorporated into the control system. Pulse Width Modulation technology serves adequately for this purpose. As the operator continues to depress the accelerator, the control system routes electrical current to the IVT drive motor 16, which adjusts the IVT off its zero point and causes the vehicle to begin accelerating. If the operator continues to depress the accelerator, the drive motor will continue to adjust the IVT up through higher gearing ratios, which adjustments will result in additional load on the motor. If the motor's amperage exceeds a predetermined limit, a light 12 on the dashboard will come on, indicating to the operator that the rate of acceleration is causing excessive amperage draw. The operator can then determine whether or not to adjust the rate of acceleration.
FIG. 4 shows the spatial configuration of the system components utilizing an integrated circuit to monitor amperage draw and control acceleration accordingly. This control 19 performs the following tasks:
   Accelerates the motor to peak range prior to engaging the IVT. The control incorporates a soft-start feature utilizing PWM technology.
   Limits total amperage available to the motor.
   Monitors the motor's amperage draw.
   Accepts input from the accelerator, and synthesize this input, making Boolean decisions that result in electrical current being transmitted to the IVT drive motor. This current will rotate the motor clockwise or counter clockwise, depending on amperage draw at any given second.
   Accepts input from the brake pedal, which the control will interpret as an instruction to lower the gearing ratio of the IVT.
FIG. 5 shows the spatial configuration of the system utilizing a continuously variable transmission (CVT) rather than an IVT. When an operator begins to depress the accelerator 20, a pulse-width-modulation circuit, which is integrated with the control system 21, is used to accelerate the vehicle from a stop using the lowest gearing ratio that the CVT 22 is capable of At the point where the drive motor reaches peak RPM, the transmission control circuit, which is integrated into the control system 21, can begin adjusting the CVT to provide an increase in vehicle speed. As the operator continues to depress the accelerator, the control system interacts with the transmission drive motor 23, causing the CVT to continue to be adjusted up through higher gearing ratios, resulting in the acceleration of the vehicle.

By way of example, and without limitation, the invention can be described as an integrated electric motor control/transmission control system for use with infinitely variable transmissions in electric vehicles

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as by claims that will be filed hereafter.

What is claimed is:

1. An integrated drive motor control/transmission control system designed to work with infinitely variable transmissions (IVT), which system allows an electric motor to be accelerated to peak rpm, where motor efficiency is at its highest level, prior to engagement of the transmission and whereby the control system modulates the variable transmission to control acceleration of the vehicle, and whereby a dashboard warning light is illuminated when amperage draw from the drive motor exceeds a predetermined limit, thus notifying the vehicle's operator of excessive amperage draw and enabling the operator to make the decision to reduce the vehicle's acceleration, or alternatively, an integrated drive motor control/transmission control system wherein the control system synthesizes feedback data from the vehicle's drivetrain and motor to intelligently determine whether the motor's amperage draw exceeds predetermined limits and then modulates the transmission so as to bring the motor's amperage draw back into predetermined limits.

2. An integrated drive motor control/transmission control system in accordance with claim 1 and claim 2 wherein the variable transmission is an infinitely variable transmission having a zero point between in the motor's rotational input and transmission's rotational output wherein the drive motor provides rotational input but the transmission's output remains at rest.

3. An integrated drive motor control/transmission control system in accordance with claim 1 wherein the variable transmission is a continuously variable transmission (CVT), which system allows the vehicle's drive motor to be accelerated to peak RPM while the CVT is set at its lowest possible gearing ratio, and wherein, when the drive motor reaches peak RPM, the control system modulates the CVT up through increasingly higher gearing ratios so as to accelerate the vehicle.
